(19) United States
(12) Patent Application Publication
(10) Pub. No.: US 2010/0007197 A1
(43) Pub. Date: Jan. 14, 2010

(54) RIM COVER FOR STROLLER, CARRIAGE OR WHEEL CHAIR

(76) Inventors: Vera Pascal, New York, NY (US); Kevin L. Hill, New York, NY (US); Alexander Karlin, Lipetsk (RU)

Correspondence Address: Kaplan Gilman & Pergament LLP, 1480 Route 9 North, Woodbridge, NJ, 07095, US

(21) Appl. No.: 12/494,596

(22) Filed: Jun. 30, 2009

Related U.S. Application Data
(60) Provisional application No. 61/134,228, filed on Jul. 8, 2008.

(51) Int. Cl. B60B 7/12

(52) U.S. Cl. 301/37.33

(57) ABSTRACT

A snap on rim cover that includes resilient extensions that hold the rim cover tightly on to the wheel rim. The rim cover and extensions are sized for particular sized rims/wheels and may offer several safety benefits based on its function of preventing external structures from entering and interacting with the rotating structures of the wheel rim. Decorative elements and reflective safety elements may also be incorporated in the rim cover; including elements of personalization thereof.

### BACKGROUND

Hub caps or covers for the rims of automobile wheels have been around for a long time. They not only provide protection to the wheel but also provide aesthetic advantages to the wheel and vehicle itself. The ‘protection of the wheel’ function can also be viewed as a safety feature in that moving parts associated with the wheel are protected from interference from external structures that could damage the moving parts as well as be damaged by the wheel moving parts. The external protected structures include human extremities, e.g. arms, legs, fingers, toes, etc.

Typical hub caps/rim covers are only useful for motor vehicles and are heavy, cumbersome and economically infeasible for lighter and less expensive conveyances such as baby strollers, baby carriages or wheelchairs. In addition, hub caps for motor vehicles often have structural elements which pose a risk of harm to human extremities when the motor vehicle, and thus the hub caps, are in motion. For example, many car hub caps have exposed openings and wires for decorative purposes and to allow access to lug nuts. The risk presented by these structures is ameliorated by the fact that human extremities are not usually exposed to a motor vehicle hub cap when the motor vehicle is in motion. With many unpowered conveyances, such as baby strollers and wheelchairs, this is not the case due to their low speed. The general mode of use and consistently low speeds of these conveyances is such that the danger of interaction between the wheel rim and external structures, including human extremities, is often a concern. In addition, the persons conveyed by these vehicles are often vulnerable to exposure to the dangers presented by such moving parts, i.e. children or handicapped individuals.

### SUMMARY OF THE INVENTION

This invention relates to a cover for the rim portion for wheels for unpowered vehicles such as baby strollers, baby carriages and wheelchairs. The subject invention offers the idea of not only personalizing the stroller, carriage or wheel chair but also providing safety qualities, e.g. preventing or minimizing contact between moving parts of the vehicle and external structures such as human hands and feet. The subject invention can have various attachments which secure the cover to the rim of the vehicle. The details of the attachments will usually vary with a brand of the stroller, carriage or wheel chair. The goal is a simple and economical snap-on rim cover which can be easily and quickly attached to the wheel. The rim cover should also be light and strong enough to prevent the wheel spokes and other inner parts of the wheel rim from breakage.

### BRIEF DESCRIPTION OF THE DRAWINGS

Features, aspects and advantages of the present invention will become better understood with reference to the following description and accompanying drawings.

FIG. 1 is a side elevation view of a rim cover showing the inner side thereof;

FIG. 1A is a cross-sectional view of the rim cover of FIG. 1, taken along section line A-A;

FIG. 1B is a cross-sectional detail view of the rim cover of FIG. 1 taken along the section line B-B;

FIG. 2 is a perspective view showing the inner side of the rim cover of FIG. 1 with additional features;

FIG. 3 is a side elevation view of a stabilizer;

FIG. 4 is a side perspective view of the rim cover of FIG. 1 engaged with the rim of a wheel, the view is of the side of the wheel adjacent the vehicle;

FIG. 5 is a side perspective view of a rim cover engaged with the rim of a wheel, the view is of the side of the wheel facing away from the vehicle;

FIG. 6 is a perspective view showing the inner side of a rim cover with connectors of an alternative embodiment;

FIG. 7 is a perspective view of a rim cover engaged with the rim of a wheel, the view is of the side of the wheel adjacent the vehicle; and

FIG. 8 is a cross-sectional view of the rim cover of FIG. 1 engaged with the rim of a wheel, the cross-sectional plane being co-planar with the wheel hub axis.

### DETAILED DESCRIPTION OF THE INVENTION

In a typical vehicular arrangement, the wheel rim is the rigid portion of a vehicle wheel disposed between a typically air filled flexible ‘tire’ and the attachment point of the wheel to the axle/bearing portion of the vehicle. Wheel rim 6 of the present invention is shown at FIG. 4. Rim 6 is shown with five ribs 5 extending between tire 12 and wheel hub 14. Wheel hub 14 receives vehicle axle 18 in a central bore 16. The wheel hub may be rigidly or rotatably attached to axle 18. Tire 12 is attached to rim 6 adjacent a peripheral portion 18 of rim 6.

Rim cover 1 of the present invention can be flat or have a shape approximating a truncated portion of a sphere or other ellipsoid. The diameter of the rim cover 1 should be approximately the same diameter as rim 6 and must not, of course, approach the diameter of tire 12.

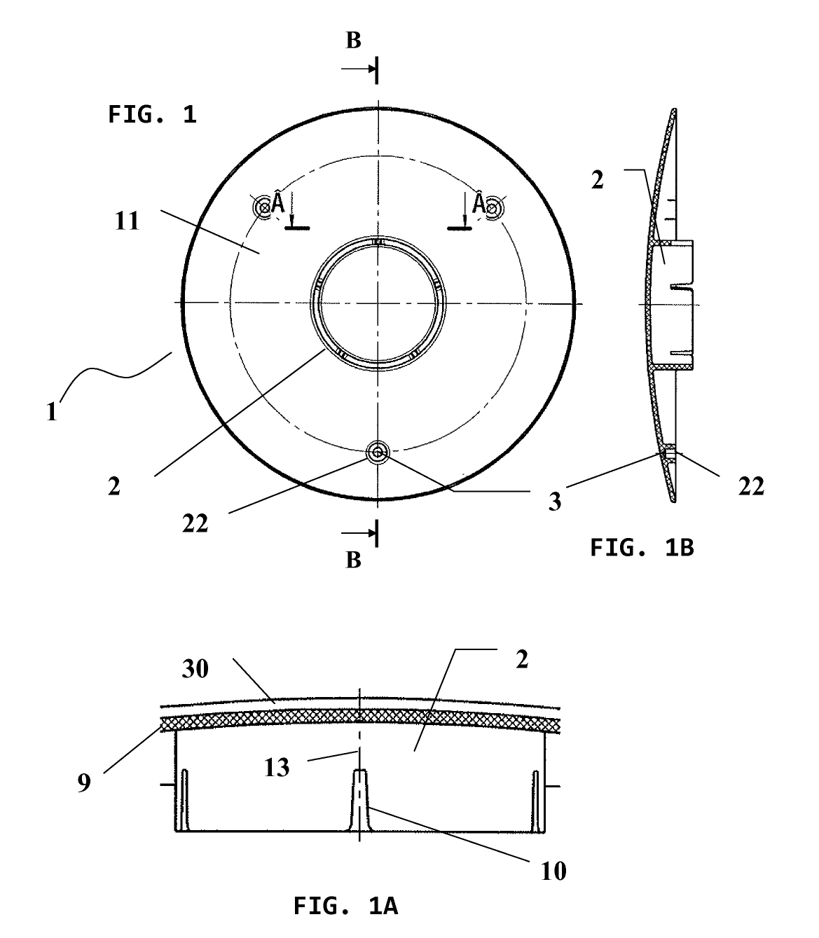

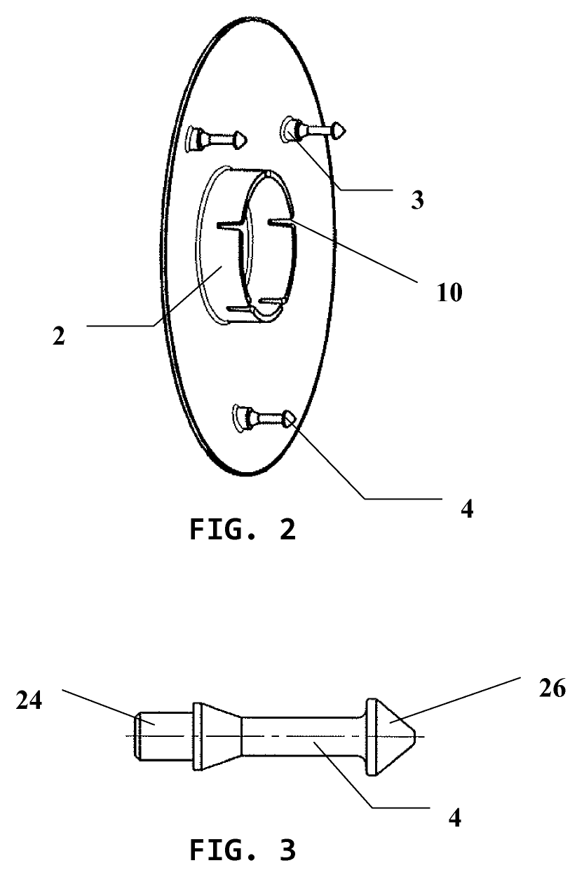

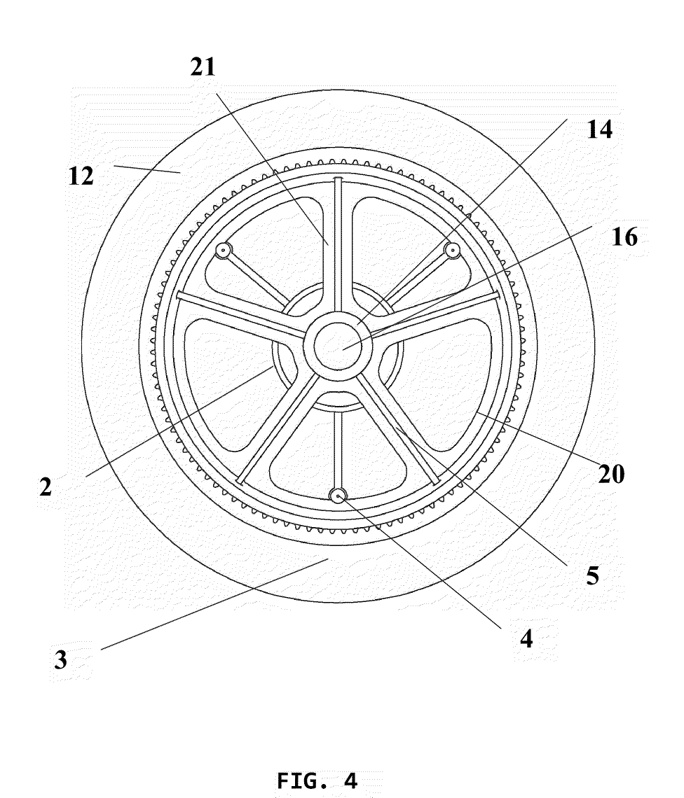

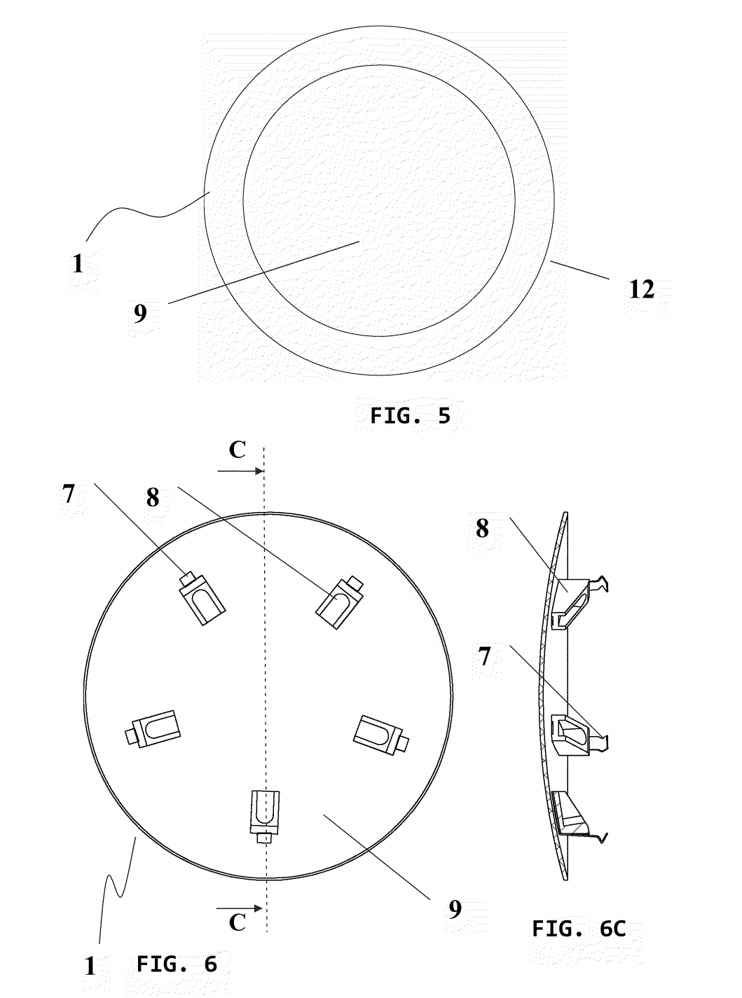

One representative embodiment of the present invention is shown in FIGS. 1-4. At the center of inner surface 11 of rim cover 1 is a ring 2 with notches 10. The ring 2 is disposed over the wheel hub 14 and has a central axis 13. Notches 10 or similar openings are provided to accommodate portions of the wheel rim ribs 5 that would prevent ring 2 from being disposed over wheel hub 14 or the rim cover 1 otherwise engaging rim 6. Notches 10 may frictionally engage the edges of the wheel rims 5, thus encouraging centered and firm placement of the cover 1 on the rim 6. Outside traction and shock absorption will be performed by this ring 2 and protect stabilizers 4 from breakage.

Also on the inner surface 11 of the rim cover 1 are a plurality of cylindrical receptacles 3, each having a central opening 22. Central openings 22 of the receptacles 3 receive a rim cover end 24 of each stabilizer 4. The rim cover end 24 is rigidly held in central opening 22, e.g. by friction fit or adhesive, thus securing the stabilizer 4 relative to the rim cover 11. As best shown at FIG. 4, stabilizers 4 are used to secure rim cover 1 on the rim 6 by means of snapping the head 26 of the stabilizers 4 onto rib 5; specifically onto circumferential rib flange 21, though radial rib flange 21 is also available for this purpose. Both the ring 2 and stabilizers 4 are used to secure a rim cover 1 firmly on the rim 6.

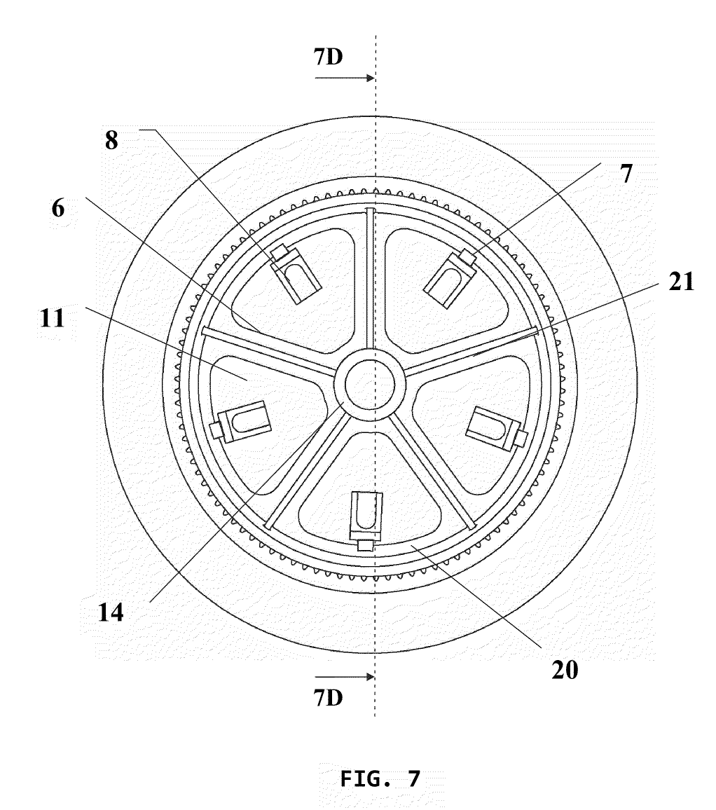

One alternative embodiment of the rim cover 1 of the present invention is shown in FIGS. 6-8. FIG. 6 shows the inner surface 11 of a rim cover 1 with a plurality of holders 8 extending therefrom. These holders 8 hold spring clamps 7 and restrict the movement of the clamps 7 and make them stable. The holders 8 and the rim cover 1 may be molded as a single integral piece. The spring clamps 7 are of a resilient material that produces a spring effect when the clamps 7 are deformed from their formed shape. Spring clamps 7 may be attached to holders 8 by glue, friction, clip, welding or any similar technique.

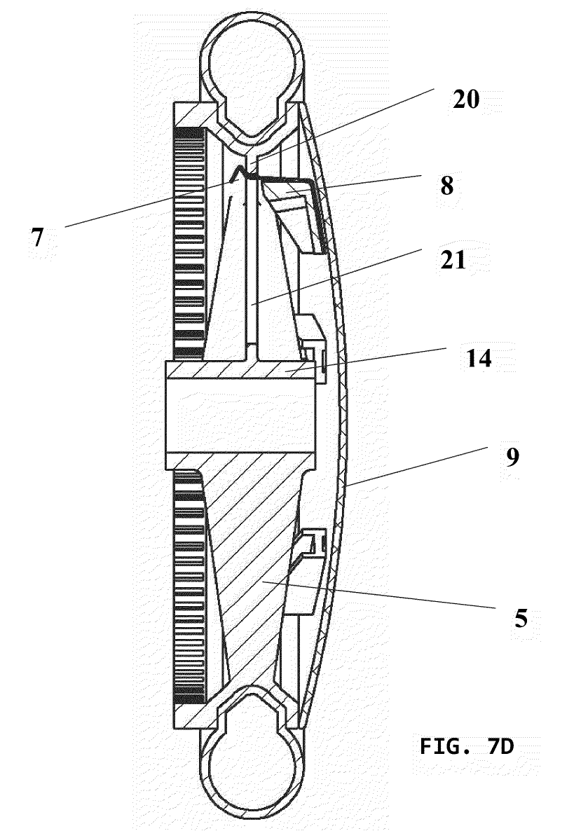

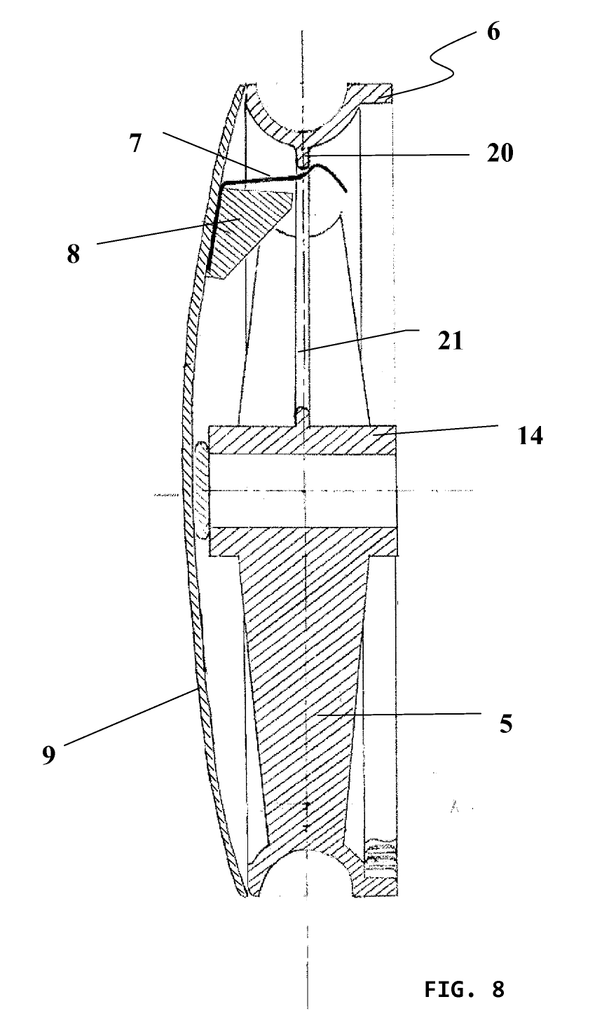

As best shown at FIGS. 7 and 8, spring clamps 7 are used to secure rim cover 1 on the rim 6 by means of deforming the spring clamp 7 onto rim flange 20. Providing a different length and orientation of the spring clamps 7, they can alternatively or simultaneously engage radial flange 21 on rib 5. In either case, the clamps 7 are shaped such that rim structures deform the resilient clips 7 and allow the clips 7 to return to the relaxed or partially relaxed state while engaging the rim structure, i.e. a force would need to be exerted such that the clips 7 would again be deformed in order to remove the clips 7 and thus the rim cover 1 from the rim 6.

Ring 2 may also be used in combination with clips 7 to secure the rim cover 1 firmly on the rim 6.

Due to the flat or minimally curved nature of the shell portion 9 of the rim cover 1, decorative elements are relatively easy to include. These decorative elements can cover some, or all, of the external surface of shell 9 and may be in the form of a coating 30. Examples of decorative elements include colors, designs, messages, pictures and advertising. The plurality of wheels of the conveyance can be provided with identical decorative elements or with elements unique to each wheel, whether related to the elements on the other wheels or independent thereof.

Some wheels have a chrome fixing cap 28 in the middle of the rim 6. If that cap 28 comes off it makes the wheel loose and eventually it comes of the axle 18. The rim cover 1, and particularly the ring 2 protects the vehicle from losing a fixing cap 28 and wheels. Thus, the present invention can act to prevent loss of a cap 28 or wheel from the conveyance.

The shell 9 may be made of recyclable plastic. For safety purposes, some or all of the shell 9 may be covered with a coating 30 that is reflective. Coating 30 may come in the form of paint, stickers or the like. The reflective nature of coating 30 make the vehicle noticeable in the darkness when crossing the road.

Besides the safety feature discussed above of preventing human extremities from interaction with the wheel, another safety feature is that the rim cover 1 prevents anything from interfering with the rims 6 and wheels. Especially when moving at a fast speed, object getting into a wheel can cause a major accident. The rim cover 1 of the present invention avoid this problem in its entirety.

The rim cover 1 also protects the stem used to fill tire 12 and its stem cap associated with the stem.

It is noted that the foregoing examples have been provided merely for the purpose of explanation and are in no way to be construed as limiting of the present invention. While the invention has been described with reference to various embodiments, it is understood that the words which have been used herein are words of description and illustration, rather than words of limitations. Further, although the invention has been described herein with reference to particular means, materials and embodiments, the invention is not intended to be limited to the particulars disclosed herein; rather, the invention extends to all functionally equivalent structures, methods and uses, such as are within the scope of the appended claims. Those skilled in the art, having the benefit of the teachings of this specification, may achieve numerous modifications thereto and changes may be made without departing from the scope and spirit of the invention in its aspects.

I claim:

1. A rim cover for one or more wheels of a non-motorized conveyance, the rim cover comprising:
a. a shell having an inner surface and an outer surface;
b. a plurality of resilient engaging structures extending from the inner surface of the shell and shaped to engage the conveyance wheel; and
c. a coating over a portion of the outer surface of the shell, the coating comprising a decorative elements.

2. The rim cover of claim 1, wherein the shell is the shape approximating a truncated sphere or ellipsoid.

3. The rim cover of claim 1, wherein the shell entirely covers an external side of a rim of the wheel such that no exterior structure may interfere with the wheel rim.

4. The rim cover of claim 1, further comprising:
a. reflective materials disposed over a portion of the outer surface of the shell.

5. The rim cover of claim 1, further comprising:
a. an annular ring extending from the inner surface of the shell, the ring and shell sharing a central axis, the ring comprising one or more notches shaped to engage the conveyance wheel and restrict rotation of the rim cover relative to the wheel.

6. A rim cover for wheels of a non-motorized conveyance, the rim cover comprising:
a. a shell having an inner surface and an outer surface;
b. means associated with the inner surface for removeably attaching the rim cover to the wheel of the conveyance; and
c. a decorative coating over a portion of the outer surface of the shell.

7. The rim cover of claim 6, wherein the shell is the shape approximating a truncated sphere or ellipsoid.

8. The rim cover of claim 6, wherein the shell entirely covers an external side of a rim of the wheel such that no exterior structure may interfere with the wheel rim.

9. The rim cover of claim 6, further comprising:
a. reflective materials disposed over a portion of the outer surface of the shell.

10. The rim cover of claim 6, further comprising:
a. ring means for supporting the rim cover.

11. The rim cover of claim 10, wherein the ring means extending from the inner surface of the shell, the ring means and shell sharing a central axis, the ring comprising one or more notches shaped to engage the conveyance wheel.
